(19) United States
(12) Patent Application Publication
(10) Pub. No.: US 2008/0124698 A1
(43) Pub. Date: May 29, 2008

(54) VIRTUAL COATINGS APPLICATION SYSTEM WITH STRUCTURED TRAINING AND REMOTE INSTRUCTOR CAPABILITIES

(76) Inventors: Jason M. Ebensberger, Cedar Falls, IA (US); Jeremiah G. Treloar, Waterloo, IA (US); Michael J. Bolick, Waterloo, IA (US); Richard J. Klein, Waterloo, IA (US); Chad J. Zalkin, San Antonio, TX (US); Malachi J. Wurpts, San Antonio, TX (US); Stephen R. Gray, San Antonio, TX (US); James B. Fisher, San Antonio, TX (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/563,842

(22) Filed: Nov. 28, 2006

(51) Int. Cl. G09B 25/00

(52) U.S. Cl. 434/365

(57) ABSTRACT

A computer simulation and virtual reality system for teaching proper spray painting techniques has features to foster structured training via planned lesson curriculum, and network capabilities that allow students to remotely view an instructor demonstrating technique on the system. The system also provides instructors software for developing lesson curriculum, managing classes, and reviewing lesson results of the students.

### FIELD OF THE INVENTION

The invention relates to the use of computer simulation and virtual reality systems for training and analyzing proper spray painting techniques. More specifically, the invention relates to enhanced capabilities that enable structured training via a planned lesson curriculum, and enhanced network capabilities that allow students to remotely view an instructor demonstrating technique.

### BACKGROUND OF THE INVENTION

The use of computer simulation and virtual reality systems to foster practice and training of proper spray painting techniques is known in the art. patent application Ser. No. 11/372,714, filed on Mar. 10, 2006 and Ser. No. 11/539,352 filed on Oct. 6, 2006, both entitled “Virtual Coatings Application System”, and assigned to the assignee of the present application, describe systems that enable a user to view and interact with real spray application equipment while simulating the application of the coating (e.g. paint) on a virtual surface. Because the application of the coating is simulated, no material is expended and harmful emissions and waste are not produced. These computer based systems also include performance monitoring and analysis software that allows a student or an instructor to monitor the student's progress.

Even though computer simulation and virtual reality training systems have many advantages and can provide a realistic training experience, it is still important for students to receive proper instruction regarding spraying techniques. One of the issues facing students with virtual reality spray paint training systems is the lack of qualified on-site instruction. An object of the present invention is to overcome this problem by providing a networked system capable of fostering meaningful remote instruction, and by also providing class management and lesson development tools so that an instructor can better teach and manage his or her class of students using such a computer based system.

### SUMMARY OF THE INVENTION

In one aspect, the invention is a networked system having multiple virtual coatings application stations. Each virtual coatings application station includes a display for displaying a virtual surface, an instrumented spray gun controller, a motion tracking system to track the position and orientation of the spray gun controller with respect to the virtual surface, a graphical user interface, and a computer programmed with software that generates virtual spray pattern data in response to the signals output from the instrumented spray gun and the position and orientation data received from the tracking system and displays virtual spray pattern data on the virtual surface in accordance with the accumulation of the computer-generated virtual spray pattern data. In accordance with this aspect of the invention, a network connection, preferably a web-based network, is provided for the multiple virtual coatings application stations. This network connection enables a logged-in instructor to operate his or her virtual coatings application station, and control, at least in part, the image displayed on one or more virtual coatings application stations at which the students are logged in. Thus, enabling the instructor to conveniently demonstrate proper spraying technique from a location remote from the respective students.

In another aspect, the invention provides a method of structured training for students with virtual coatings application stations, namely the ability of an instructor to plan a training curriculum in the form of one or more virtual spray painting lessons, each having minimum performance standards for selected performance criteria set for passing grades. The instructor is given the ability to require that students pass certain lessons on a virtual coatings application station before having access to other lessons. In this regard, the invention provides software to allow the instructor to conveniently program lesson parameters, as well as manage classes and student lesson results. For example, the lessons can be programmed by an instructor to provide training for various types of workpiece configurations and orientations, surfaces, finishes, camouflage outlines, and the like.

Preferably, a student logged into the system chooses between network mode, in which they can receive remote demonstrations from an instructor logged onto the network, or structured training mode or freeplay mode. In the structured training mode, the student user selects lessons from the programmed curriculum and operates his or her virtual coatings application station in accordance with the lesson. The student's performance during the lesson is monitored and saved in a central database associated with the web-based network. These saved lessons results can later be reviewed by the instructor and/or the student. In freeplay, the user is able to practice without performance monitoring.

Various other details and features of the invention are described hereinafter in reference to the drawings.

### BRIEF DESCRIPTION OF THE DRAWINGS

FIG. 1 is a schematic drawing illustrating a person using a virtual coatings application in which a virtual surface is displayed on a screen display.

FIG. 2 is a schematic drawing illustrating an instrumented spray gun controller used to simulate a typical high volume, low pressure spray gun.

FIG. 3 is a cross-sectional view of the spray gun controller shown in FIG. 2 partially assembled.

FIG. 4 depicts a two-dimensional image of a door defining a virtual surface on a display screen, where overspray is depicted in a color distinct from the color of virtual paint sprayed onto the image of the door.

FIG. 4A depicts a two-dimensional image of a door similar to that shown in FIG. 4, where the door has been prepared with virtual chalk marks outlining a desired camouflage design.

FIG. 5 is a schematic drawing illustrating a person using a virtual coatings application station utilizing a head-mounted display unit 98 which depicts a virtual surface within a virtual spray painting environment observed by a user wearing the head-mounted display unit.

FIG. 6 illustrates a representative view observed by a person wearing a head-mounted display unit, as shown in FIG. 5.

FIG. 7 is a schematic drawing illustrating a web-based network accessible by multiple virtual coatings application stations in accordance with a preferred embodiment of the invention.

FIG. 8 illustrates the preferred form of a lesson mode selection screen which is displayed on the graphical user interface of a virtual coatings application station in accordance with the preferred embodiment of the invention.

FIGS. 9-13 are schematic flow diagrams illustrating the functions of the graphical user interface software for a virtual coatings application station in accordance with the preferred embodiment of the invention.

FIG. 14 is an illustrative view of the preferred form of a lesson selection screen for the graphical user interface for a virtual coatings application station in accordance with the preferred embodiment of the invention.

FIG. 15 is the preferred form for a lesson in progress screen for the graphical user interface for a virtual coatings application station in accordance with the preferred embodiment of the invention.

FIG. 16 is the preferred form for a network mode selection screen for the graphical user interface for a virtual coatings application station in accordance with the preferred embodiment of the invention.

FIG. 17 is the preferred form for a sender mode configuration screen for the graphical user interface for a virtual coatings application station in accordance with the preferred embodiment of the invention.

FIG. 18 is the preferred form for a receiver mode configuration screen for the graphical user interface for a virtual coatings application station in accordance with the preferred embodiment of the invention.

FIG. 19 is the preferred form for a receiver station connection screen for the graphical user interface for a virtual coatings application station in accordance with the preferred embodiment of the invention.

FIG. 20 is a preferred form for a scoresheet selection screen for the graphical user interface for a virtual coatings application station in accordance with the preferred embodiment of the invention.

FIG. 21 illustrates a preferred form for a scoresheet viewer screen for the graphical user interface for a virtual coatings application station in accordance with the preferred embodiment of the invention.

FIG. 22 illustrates a preferred form for a lesson report screen for the graphical user interface for a virtual coatings application station in accordance with the preferred embodiment of the invention.

FIG. 22A illustrates an alternative performance display image preferably used for the lesson report screen when the lesson is a camouflage lesson.

FIG. 23 illustrates a preferred form for a lesson administration screen for the graphical user interface for a virtual coatings application station in accordance with the preferred embodiment of the invention.

FIG. 24 illustrates the preferred form for an edit lesson screen for the graphical user interface for a virtual coatings application station in accordance with the preferred embodiment of the invention.

### DETAILED DESCRIPTION OF THE INVENTION

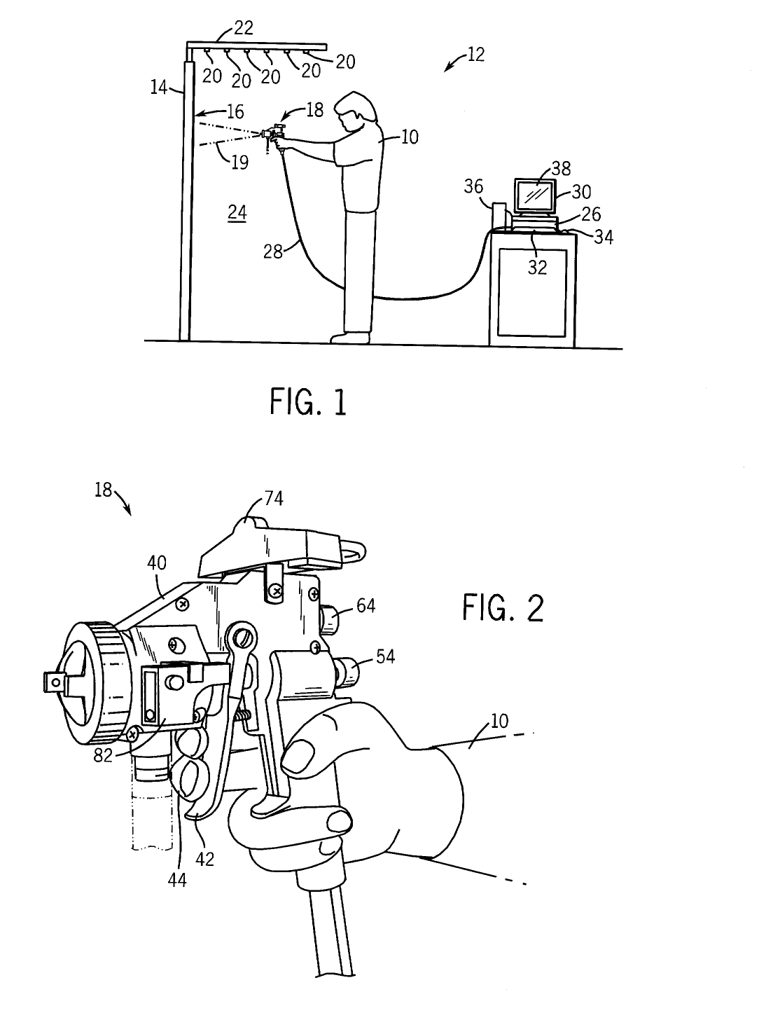

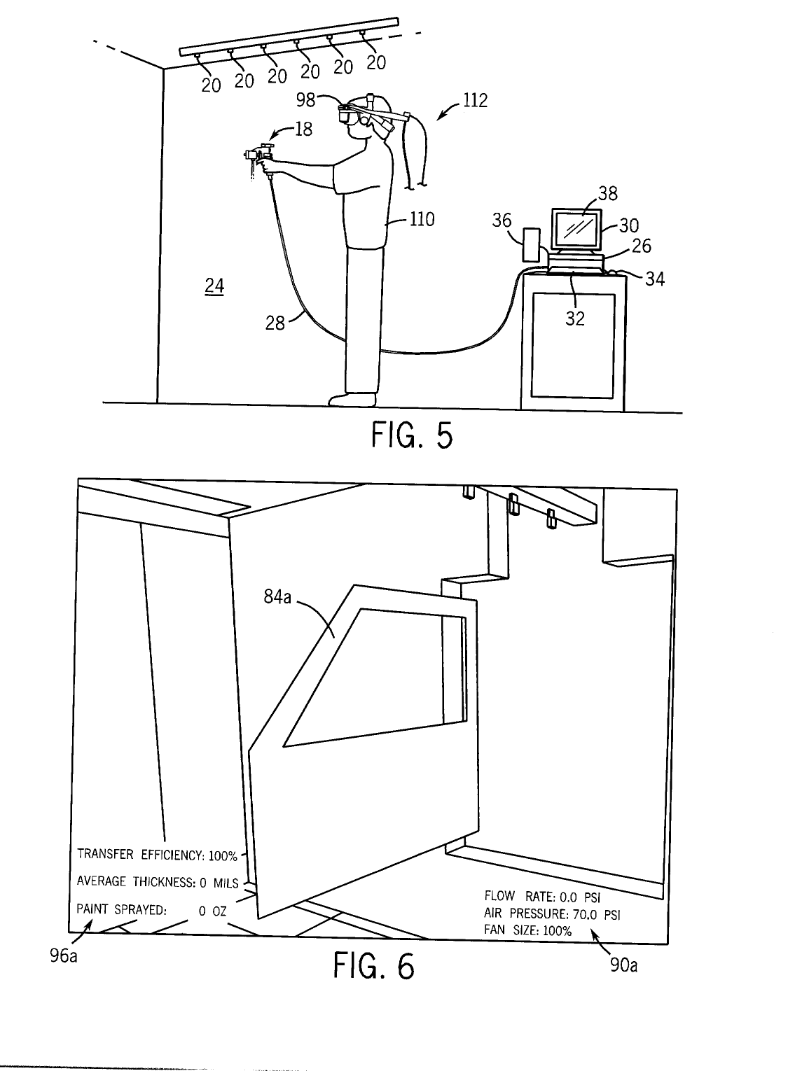

FIGS. 1-3 show a student (or instructor) 10 using an embodiment of a virtual coatings application station 12 in accordance with the prior art, as described in copending patent application Ser. Nos. 11/372,714 and 11/539,352 incorporated herein by reference. FIG. 5 illustrates the student (or instructor) 10 using another embodiment of a virtual coatings application station 112 in accordance with the prior art, which is disclosed in the above referenced copending patent application Ser. No. 11/539,352, which is incorporated herein by reference. Either type of station 12, 112 can be used in accordance with the present invention. Referring to FIG. 1, the virtual coatings application station 12 is intended to be used to teach painting techniques by allowing a student 10 to repeat the painting process an unlimited amount of times without any required preparation or paint mixing. The station 12 helps painters learn the best approach for painting a part, and can be used to screen potential painters for general skills and abilities. The virtual coatings application station 12 includes a display screen 14, preferably on a large projection screen television, although other types of display screens can be used. A 72-inch screen (measured on the diagonal) provides a suitable amount of virtual work area, although an 86-inch screen is preferred. The station 12 defines a virtual surface on the front surface 16 of the display screen 14. The student 10 is holding an instrumented spray gun controller 18, and is operating the controller 18 to apply a virtual coating or layers of coatings to the virtual surface defined on the screen surface 16. FIG. 1 shows an imaginary virtual spray 19 being applied to the virtual surface on the screen surface 16, although the imaginary virtual spray 19 is not actually visible. As described in the incorporated copending patent applications, the position and orientation of the spray gun controller 18 is monitored using a tracking system, preferably a six degree of freedom tracking system that monitors translation in the x, y and z direction, as well as pitch, yaw and roll. The preferred tracking system is a highbred inertial and ultrasonic tracking system, although many aspects of the invention may be implemented using other types of tracking technologies. FIG. 1 schematically depicts an arrangement of ultrasonic transmitters 20 mounted to a frame 22 extending over the space in front of the virtual surface 16. The space in front of the virtual surface is referred to as the virtual workspace 24.

The instrumented spray gun controller 18 is connected to a computer 26 preferably in part via a USB cable connection 28. A monitor 30, keyboard 32 and mouse 34 are connected to the computer 26, as well as one or more loudspeakers 36. The virtual coatings application station 12 includes a graphical user interface 38 that is displayed on the computer monitor 30 in accordance with software described herein.

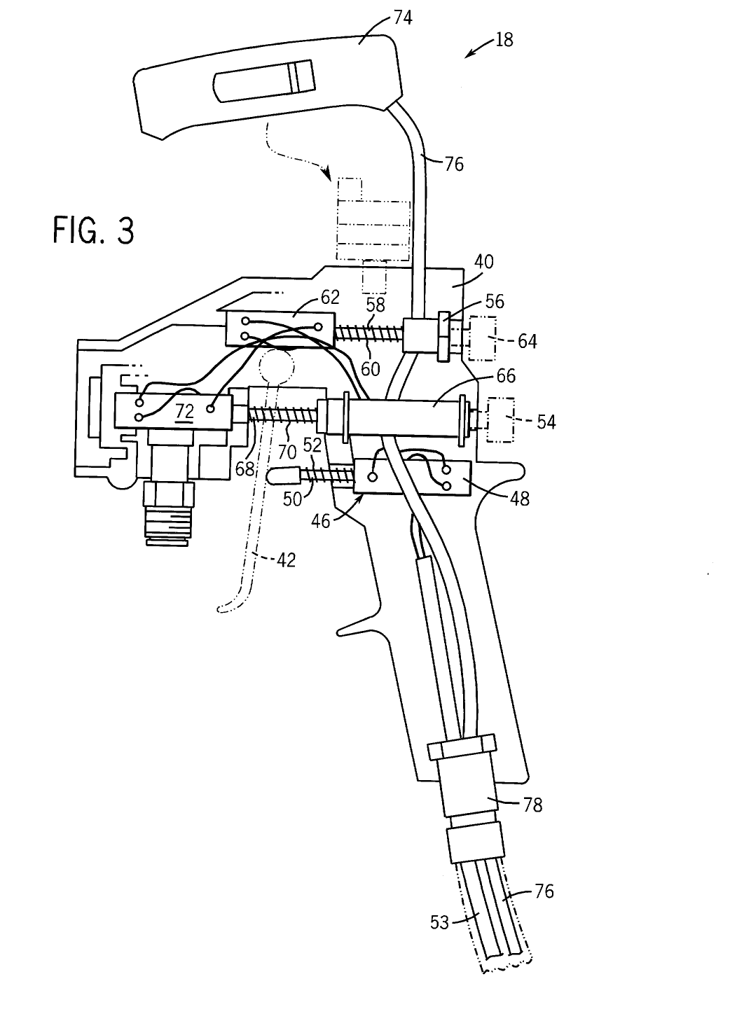

FIGS. 2 and 3 show the preferred instrumented spray gun controller 18 in detail. The controller 18 is an actual high volume, low pressure spray gun that has been instrumented with electronic sensors in order to provide a realistic interactive experience for the person 10 using the controller 18. The controller 18 includes a housing 40 which has been machined or otherwise formed to accommodate the electrical components of the controller 18. The controller 18 has a trigger 42 that is variably positionable in response to pressure applied by the fingers of the user 10. The position of the trigger 42 is sensed by position sensor 46. The trigger position sensor 46 is a potentiometer 48 that senses the tension on spring 50 located on rod 52 and outputs a signal representing trigger position data. The signal is transmitted to the computer 26 via wires in cable 53 (which lead to a USB connection kit 28). The computer 26 monitors the signal from the potentiometer 48 every timing cycle to detect the position of the trigger 42. As discussed in copending patent application Ser. Nos. 11/372,714 and 11/539,352, use of the trigger sensor 46 to detect the variable position of the trigger 42 allows for the user 10 to realistically apply a partial spray to the virtual surface on the display screen 16. The instrumented spray gun controller 18 also includes a flow rate control knob 54. The user 10 turns the flow rate control knob 54 to adjust the maximum virtual flow rate for the spray gun controller 18. In actual high volume, low pressure spray guns, a needle valve is typically used to adjust fluid pressure and hence fluid flow rate. In FIG. 3, the head of knob 54 is shown in phantom. FIG. 3 also shows a bushing 66 that receives the knob 54, and rod 68 and spring 70 leading from the bushing 66 to potentiometer 72. The potentiometer 72 senses the position of the flow rate knob 54 and generates a signal representing maximum virtual fluid flow rate which is sent via wires in cable 53, 28 to a computer 26. The maximum virtual flow rate is used by simulation software in the computer 26 to scale the trigger position data. The maximum virtual flow rate can also be adjusted using the graphical user interface 38. The spray gun controller 18 also includes a fan-sized adjustment knob 64, FIG. 2. The user can rotate the fan-sized adjustment knob 64 to adjust the fan size of the virtual spray 19, in a manner similar to that on an actual high volume, low pressure spray gun. In FIG. 3, the head of the fan-sized control knob 64 is shown in phantom. The fan-sized control knob 64 screws into a bushing 56 that is mounted inside the spray gun controller housing 40. The rod and spring mechanism 58, 60 lead from the bushing 56 to a potentiometer 62. As the stem of the fan-size control knob 64 pushes on the rod 58, the potentiometer 62 monitors the tension on the spring to detect the desired fan size for the virtual spray 19. The fan size can also be adjusted on the graphical user interface 38. A signal generated by potentiometer 72 is sent through wires in cable 53, 28 to the computer 26.

As also described in copending patent application Ser. Nos. 11/372,714 and 11/539,352, the preferred spray gun controller 18 is also instrumented with a highbred inertial and acoustic sensor 74, which is mounted to the top surface of the controller 18. The preferred inertial and ultrasonic sensor 74 is supplied along with the other components of the tracking system from Intersense, Inc. of Bedford, Massachusetts. The preferred sensor is the Intersense IS-900 PC tracker device. The sensor includes accelerometers and gyroscopes for inertial measurement and a microphone for measuring ultrasonic signals from the beacon of ultrasonic transmitters 20, see FIG. 1. The preferred arrangement of ultrasonic transmitters consists of a SoniFrame™ emitter with two 6 foot SoniStrip™ and one 4 foot SoniStrip™ from Intersense, and provides a tracking volume of approximately 2 meters×2 meters×3 meters for the virtual workspace 24. The ultrasonic transmitters 20 receive timing signals from tracking software in the computer 26. The sensor microphone detects high frequency signals from the ultrasonic transmitters, and the sensor accelerometers and gyroscope devices generate inertial position and orientation data. Inertial measurements provide smooth and responsive sensing of motion, but accumulation of noise in the signals can cause drift. The ultrasonic measurements are used to correct such drift. The sensor 74 located on the spray gun controller 18 outputs a six degree of freedom signal, namely x, y, z for linear directions and pitch, yaw and roll for angular directions. The signals from the sensor 74 are transmitted to a cable 76 which is fed through the controller housing 40 and exits the bottom of the housing through a bushing 78, similar to cable 53. Cable 76 along with cable 53 are sent to the computer 26, with cable 76 being sent via a hub for the tracking system and cable 53 via a USB connection 28 as mentioned. The position and orientation of the sensor 74 is determined based on software in the computer 26, thus determining the position and orientation of the spray gun controller 18 in the virtual workspace 24 in front of the display screen surface 16. While it is possible for the connections from the spray gun controller 18 to the computer 26 to be wireless connections, it is preferred that a hose be used to house cables 53 and 76 in order to simulate a compressed air hose feeding an actual spray gun. Those skilled in the art will recognize that the spray gun controller 18 allows the user 10 to make typical adjustments that would be made using a high volume, low pressure spray gun in the field. FIG. 2 also shows a mock laser targeting position system 82 mounted to the housing 40 of the spray gun controller 18, as described in the incorporated application Ser. Nos. 11/372,714 and 11/539,352.

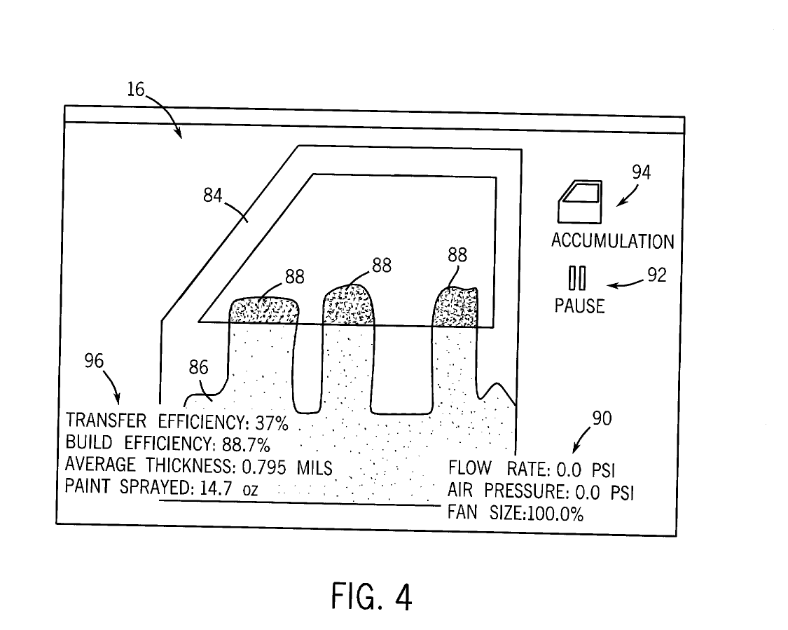

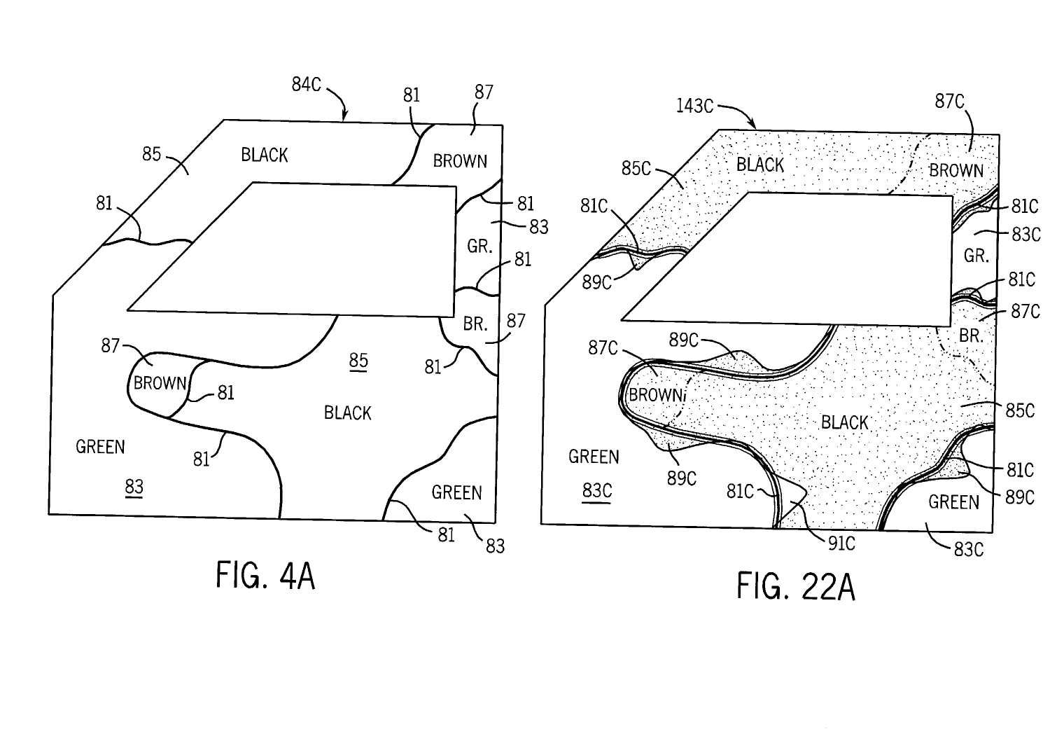

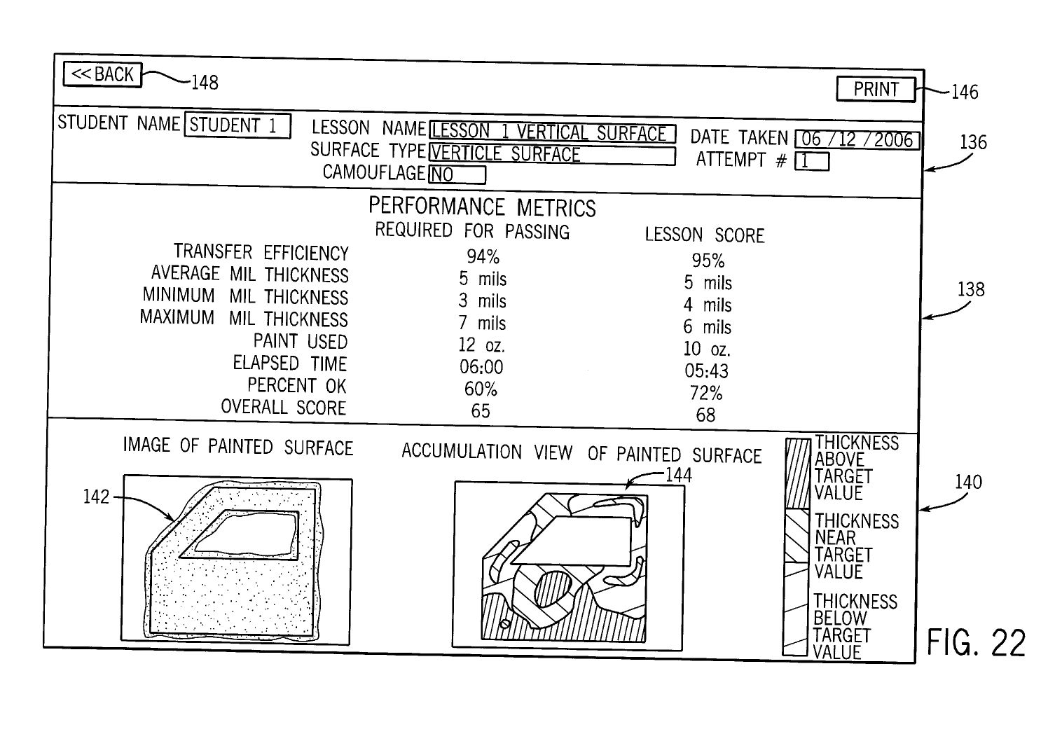

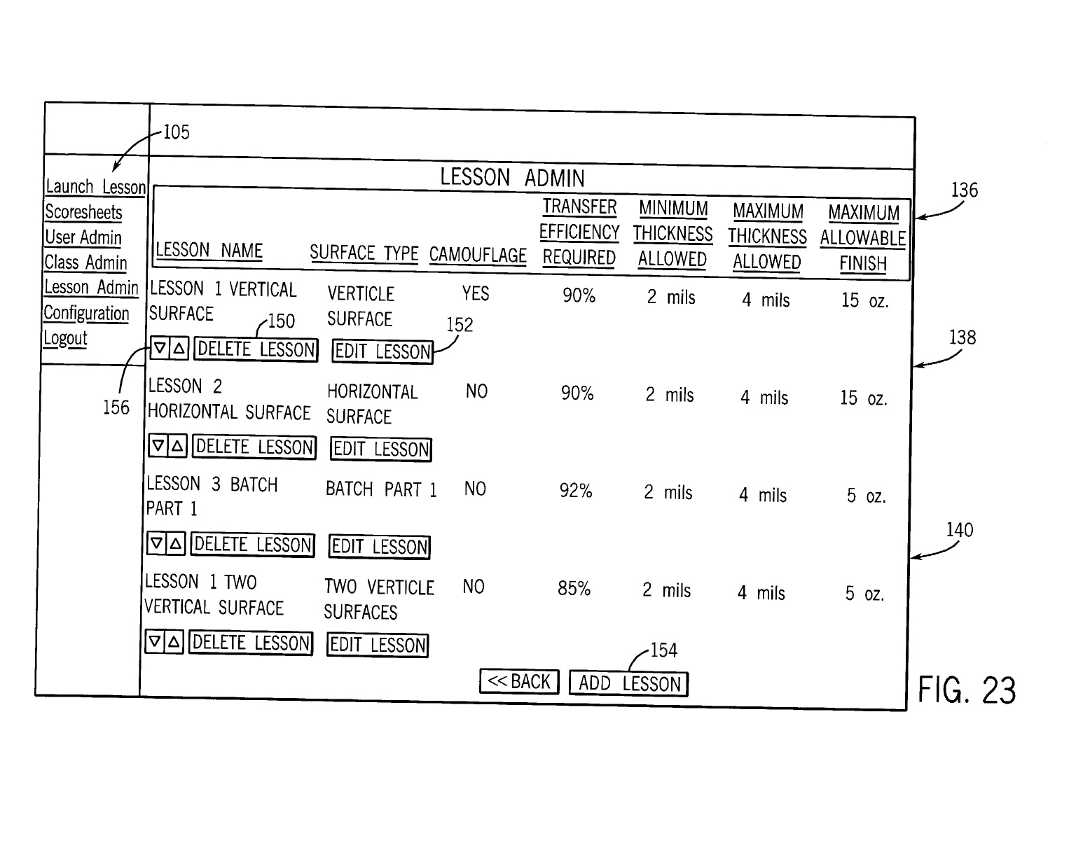

As described in much more detail in copending patent application Ser. Nos. 11/372,714 and 11/539,352, software in the system generates virtual spray pattern data in response to signals outputting the instrumented spray gun controller (i.e. virtual spray gun data) and the position and orientation data received from the tracking signal. Preferably, the software uses a realistic paint model to generate the virtual spray pattern data, such as described in copending U.S. patent application Ser. Nos. 11/372,714 and 11/539,352, which characterizes the resulting pattern of the virtual spray in terms of spatter size and density on the virtual surface as a function of time in response to at least a standoff distance and angular orientation of the spray gun controller 18 relative to the virtual surface as well as virtual spray characteristic data representing the settings for the spray fan size, air pressure and paint flow rate. FIG. 4 illustrates a virtual surface 84 in the form of a truck door being displayed on the display screen surface 16 in the station 12, shown in FIG. 1. The region illustrated by reference number 86 is virtual paint that has been applied to the virtual surface 84. Regions 88 indicate overspray. Also displayed on the screen surface 16 are spray gun setting parameters 90, a pause icon 92, an accumulation mode icon 94 and performance criteria for the session 96, all explained in the above-incorporated application Ser. Nos. 11/372,714 and 11/539,352. There are many more details of the station 12 disclosed in copending application Ser. Nos. 11/372,714 and 11/539,352, and it should be understood that these details and features may be incorporated into the system of the present invention where appropriate. In one embodiment, the displayed performance criteria 96 includes the following data for the session: transfer efficiency, minimum thickness, maximum thickness, average thickness, paint sprayed (oz.), percent OK, and overall score. These performance metrics are discussed in connection with FIG. 22.

FIG. 4A illustrates a virtual surface 84c of the type used when the system is in camouflage mode, as an alternative to the virtual surface 84 shown in FIG. 4. In FIG. 4A, the virtual surface 84A is typically pre-painted with a background color, such as green. Virtual chalk lines 81 appear on the virtual surface in order to delineate the boundaries between regions that should remain the background color, e.g. green, as depicted by regions labeled with reference number 83, and the regions 85 that should be painted brown and the regions 87 that should be painted black. In FIG. 4A, the truck door 84c is shown with the background painted green and the chalk lines 81 being drawn on the pre-painted surface, however, no virtual paint for the camouflage overcoats has been applied to the virtual surface 84c. When in camouflage mode, the user 10 uses the instrumented spray gun controller 18 to virtually paint the virtual surface 84c with the intent of virtually painting the brown regions 85 and black regions 87 to paint over the chalk lines 81 but not beyond the chalk lines 81.

FIG. 5 shows a virtual coatings application station 112 with alternative means for displaying the virtual spray painting environment and virtual surface, namely an immersive head-mounted display unit 98 worn on the head of the user 110. FIG. 5 shows the head-mounted display unit on the head of the user 110 located within the virtual workspace 24. Note that the station 112 does not require a screen display, but otherwise the system components are generally similar as described with respect to the embodiment in which the virtual surface was on a screen display 16. Note, however, that the position and orientation of the head-mounted display unit 98 is also tracked by the same or a similar tracking system that tracks the position and orientation of the spray gun controller 18. For example, it may be desirable to track the head-mounted display unit 98 with an Ascension™ Flock of Birds tracking system. FIG. 6 shows a virtual surface 84a in the form of a vertically hanging truck door within a virtual spray painting environment as would typically be seen by a user 110 wearing the head-mounted display unit 98. Note that the display shows spray gun settings 90a and performance criteria 96a. Although not shown in FIG. 6, it is desirable that the display show the position and orientation of the spray gun controller 18 and optionally a three-dimensional cone of virtual spray being sprayed from the controller 18. Other aspects of the station 112 are disclosed in incorporated application Ser. No. 11/539,352.

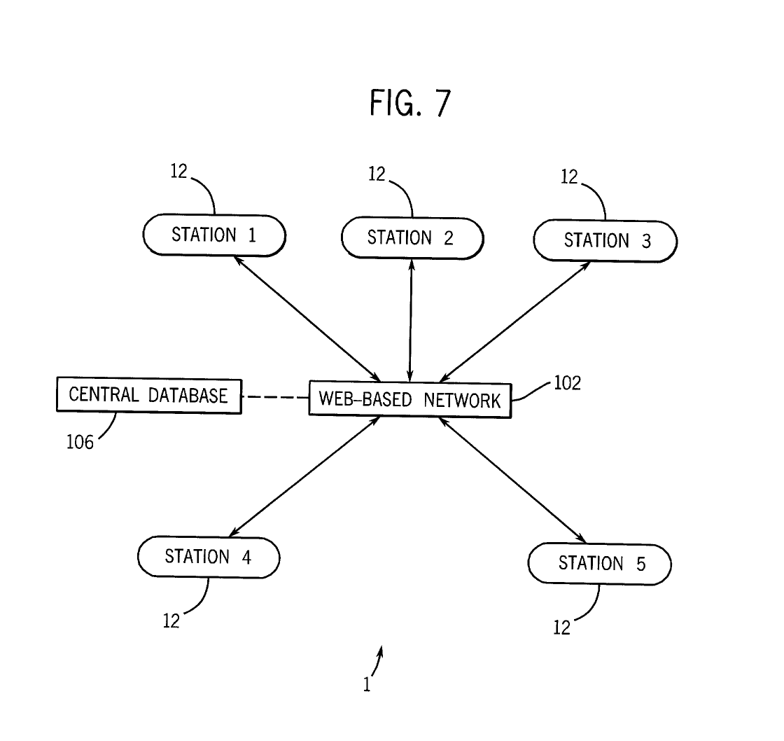

Referring now to FIG. 7, a system 1 in accordance with the invention preferably has multiple instructor/operator stations 12 as shown in FIG. 1 (or stations 112 as shown in FIG. 5). Each station 12, 112 has access to and is able to interact with a web-based network 102. Each station 12, 112 has a graphical user interface that allows the users of the stations to interact with and control various aspects of the system software. The preferred graphical user interface executes within a web browser 102, e.g., preferably the Microsoft Internet Explorer web browser. As mentioned, the web-based graphical user interface provides features that enhance remote instruction and structured training capabilities.

It should be understood that the invention can be implemented using multiple instructor/operator stations 12, as shown in FIG. 1, in which the virtual surface is depicted on a display screen 16, as shown in FIG. 1, and can also be implemented using multiple instructor/operator stations using an immersive head-mounted display unit 98, such as shown with respect to station 112 shown in FIG. 5. In either case, the stations 12 or 112 are each provided with a graphical user interface that allows the users of the stations to interact with and control various aspects of the system software. Note that each station 12 or 112 can be used by either a student or an instructor, depending on how the station 12 or 112 is logged in to the system 1. For the sake of simplicity, the invention is described hereinafter with respect to its implementation using instructor/operator stations 12, as shown in FIG. 1.

Referring now in particular to the preferred graphical user interface 38 on the computer monitor 30, the VCAS application is started using an icon on the screen of the computer monitor 30. Once started, a login screen appears which preferably allows the user to login under an existing student or existing instructor account. Usernames and passwords are stored in a central database 104 associated with the web-based network 102 so that all stations 12 with network access to the database are able to verify username and password pairs.

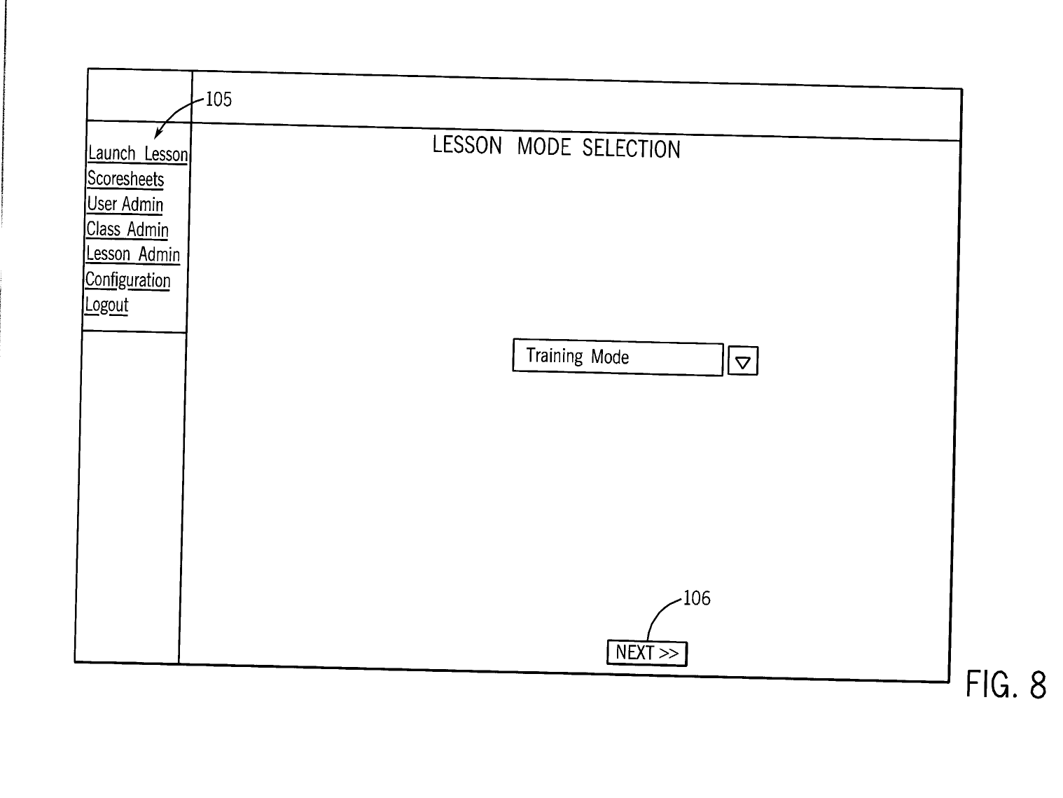

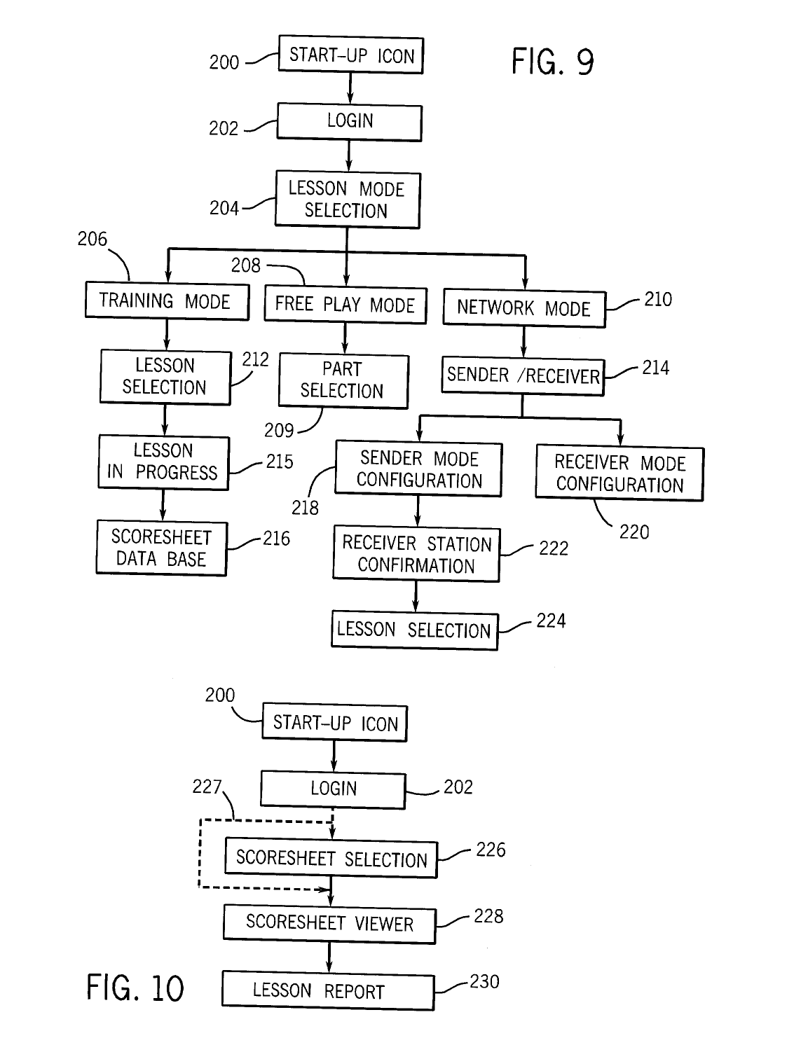

After successful login, the user is taken to the lesson mode selection screen shown in FIG. 8. The screen in FIG. 8, as well as most of the other screens for the graphical user interface, preferably includes a main menu 105 including the following choices: “Launch Lesson”, “Scoresheets”, “User Admin”, “Class Admin”, “Lesson Admin”, “Configuration”, and “Logout”. Alternatively, it may be desirable to place the “User Admin”, “Class Admin”, “Lesson Admin” menu options under a general “Admin” menu selection. FIGS. 9-13 are flow diagrams showing progress through the various menus and submenus under each of these menu choices, except for the Configuration and Logout links, which are relatively simple in the preferred embodiment. Note that FIG. 9 indicates the direct progression from login, box 202, to the lesson mode selection screen, box 204, with a solid arrow, whereas the progression from the login screen, box 202, to the other functions, namely Scoresheets, User Admin, Class Admin, Lesson Admin are indicated with a dashed arrow indicating that these functions are available indirectly after login using the main menu 105.

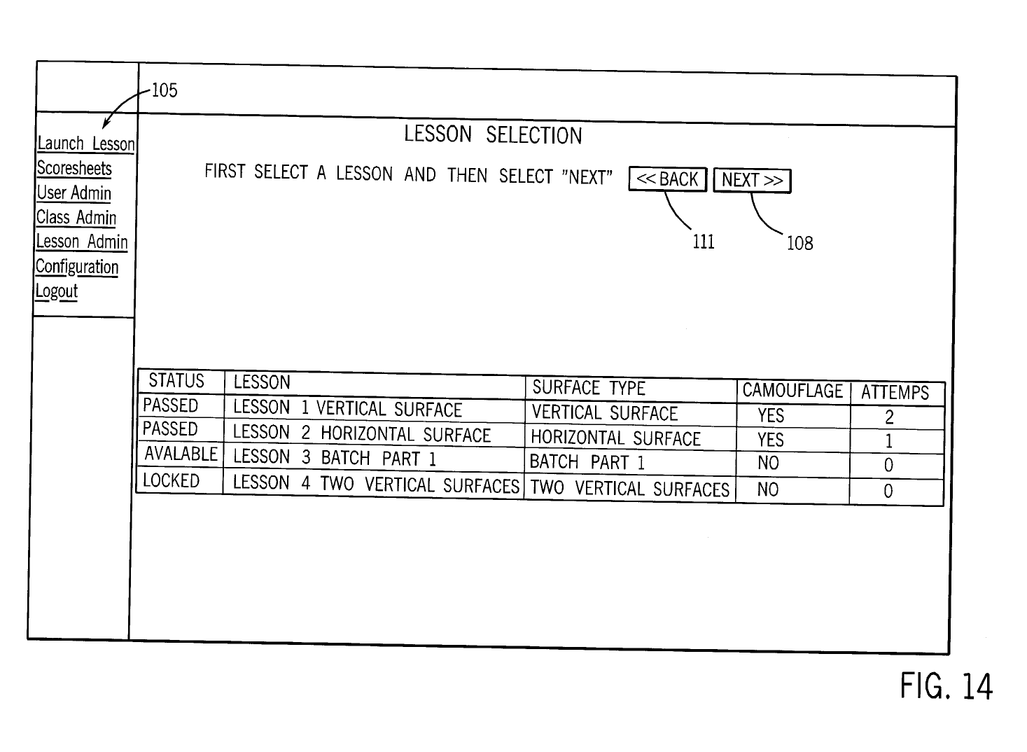

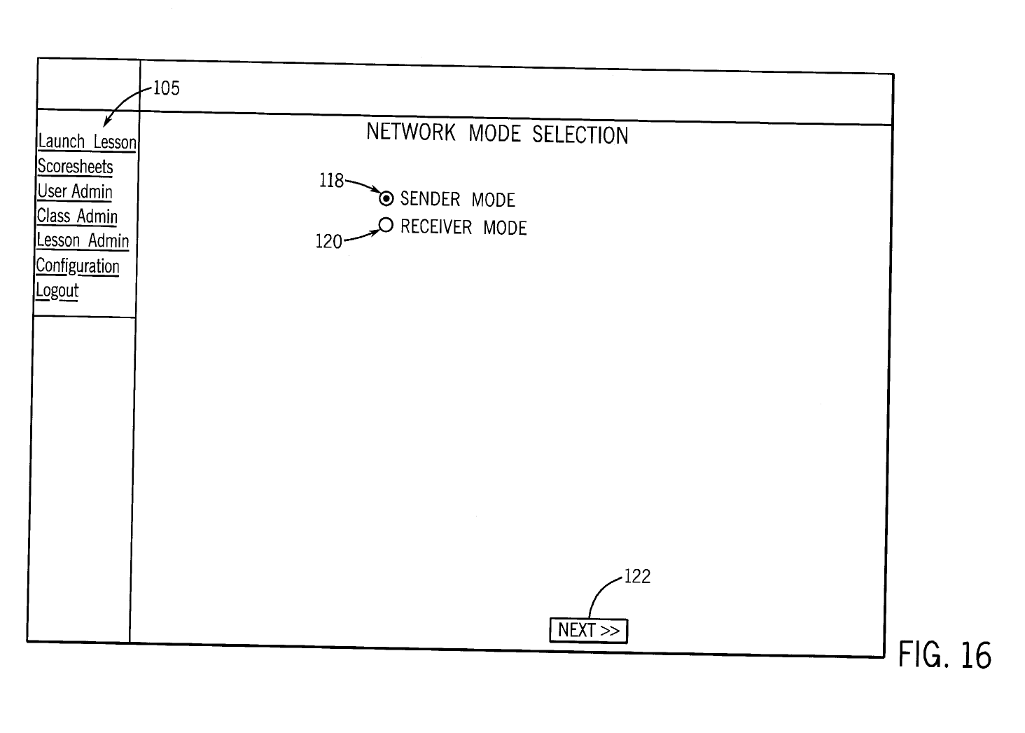

Referring briefly to FIG. 9, when the user activates the startup icon, box 200, and logs in to the system, box 202, the lesson mode selection screen (FIG. 8) appears on the graphical user interface, box 204. The lesson mode selection screen (FIG. 8) allows the user to select the mode in which training will take place. Available selections are training mode, box 206, freeplay mode, box 208, and network mode, box 210. When the user selects the next button 106 in FIG. 8, the next screen shown depends on the mode 206, 208, or 210 selected by the user. If the user selects training mode 206, the next screen displayed is the lesson selection screen (FIG. 14) as depicted by box 212 in FIG. 9. If the user selects freeplay mode 208, the next screen displayed is a part selection screen as depicted by box 209. The part selection screen (not shown) preferably allows the user to select from various part configurations to be displayed as a blank virtual surface on the display screen. The user then virtually paints the selected virtual surface in freeplay mode without any performance monitoring. If the user selects network mode 210, the next screen displayed is the network mode selection screen (FIG. 16) as depicted by box 214 in FIG. 9.

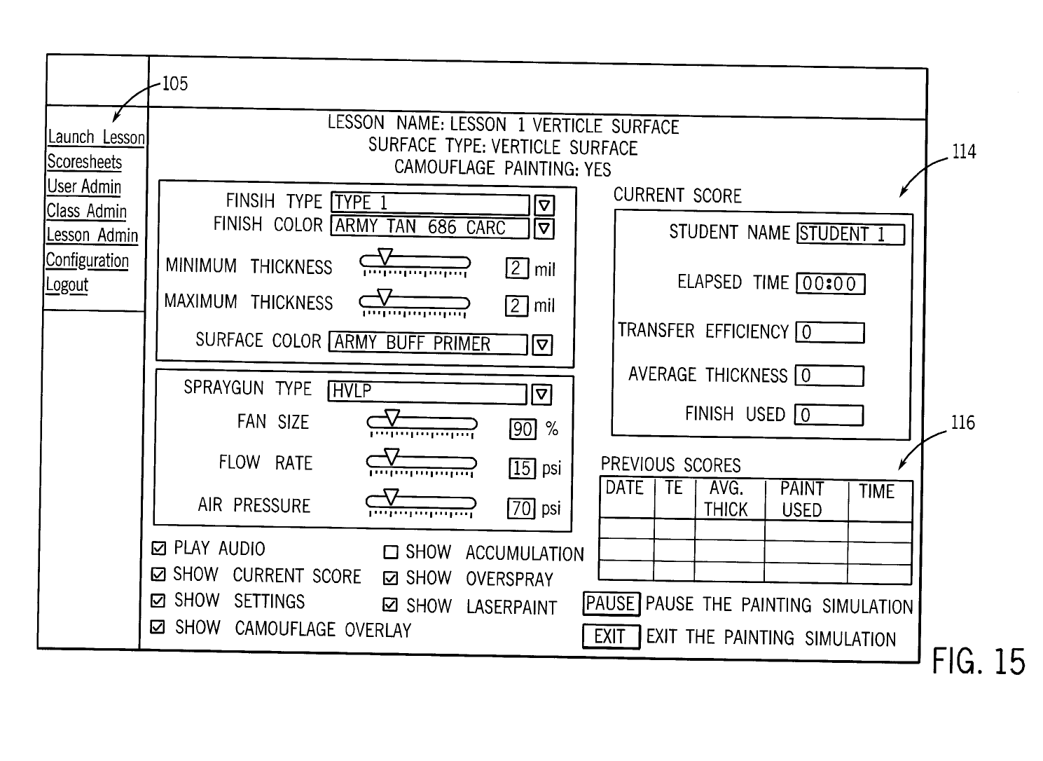

Referring now to the lesson selection screen shown in FIG. 14, the user is able to select from available lessons shown on the screen. Information such as lesson status, lesson name, surface type, whether or not camouflage is used in the lesson, and number of attempts the currently logged-in user has attempted the listed lesson are preferably shown on the screen. Preferably, the status of the lesson can be one of the following: available, passed, failed, or locked (i.e. not available). When training mode 206 is selected from the lesson mode screen (FIG. 8), then only the next lesson after the successfully completed lessons is marked as available. All other lessons are marked as locked (i.e. not available). Once the user has completed the lesson with a passing score, then the lesson is marked as passed. If the user has completed a lesson with less than a passing score, the lesson is marked as failed. The user is able to re-take failed lessons, and is also able to re-take a passed lesson if the user would like, e.g., to improve his or her score. Once the user selects an available lesson and clicks the next button 108 in FIG. 14, the lesson in progress screen of (FIG. 15) is displayed as depicted by box 214 in FIG. 9. Selecting the back button 111 on FIG. 14 returns the user to the lesson mode selection screen (FIG. 8).

The lesson in progress screen shown in FIG. 15 appears on the graphical user interface to control and monitor the users virtual painting session. From the lesson in progress screen (FIG. 15), the user is able to modify simulation variables, monitor progress of the current session, arrow 114, and view previous scores for the current lesson, arrow 116. The items listed on the lesson in progress screen are described in Table 1 below. The third column in Table 1 specifies whether the control is enabled when operating as a student or receiver station in network mode 210, as described hereinafter.

TABLE 1
Description of items on Lesson In Progress Screen

| | | Active in Network |
|---|---|---|
| | | Receiver Mode |
| Item | Description | (student)? |
| Finish Type | Specifies the type of finish being used with the | No |
| | spray gun. This control is a read-only indicator | |
| | during Training Mode. | |
| Finish Color | Allows the user to change the color of the finish | No |
| | used with the spray gun. | |
| Minimum Thickness | Allows the user to change the minimum specified | No |
| | thickness that the painter is targeting. This control | |
| | is a read-only indicator during Training Mode. | |
| Maximum Thickness | Allows the user to change the maximum specified | No |
| | thickness that the painter is targeting. This control | |
| | is a read-only indicator during Training Mode. | |
| Surface Color | Allows the user to change the color of the surface | No |
| | being painted. The user will be presented with a | |
| | confirmation dialog when the surface color is | |
| | changed. If the user confirms the action, the surface | |
| | color will be changed and all paint previously | |
| | sprayed will be removed. If the surface color | |
| | selected matches the finish color selected, the user | |
| | will see a confirmation dialog. This control is a | |
| | read-only indicator during Training Mode. | |
| Spray Gun Type | Specifies what type of spray gun is being used. This | No |
| | control is a read-only indicator during Training | |
| | Mode. | |
| Fan Size | Shows the value of the fan size control located on | No |
| | the spray gun. It also allows the user to override the | |
| | spray gun control by manually changing the control | |
| | from this screen. The last modified control (either | |
| | the GUI or the spray gun control) is the value that is | |
| | displayed by this screen and used by the simulation. | |
| Air Pressure | Allows the user to change the air pressure used with | No |
| | the spray gun. | |
| Flow Rate | Shows the value of the flow rate control located on | No |
| | the spray gun. It also allows the user to override the | |
| | spray gun control by manually changing the control | |
| | from this screen. The last modified control (either | |
| | the GUI or the spray gun control) is the value that is | |
| | displayed by this screen and used by the simulation. | |
| Play Audio | Allows the user to turn on/off the sound effects from | Yes |
| | the software. | |
| Show Overspray | Allows the user to toggle the display of the | Yes |
| | overspray paint. | |
| Show Current Score | Allows the user to toggle the displays of the | Yes |
| | student's scores in the display system. | |
| Show Settings | Allows the user to toggle the display of the spray | Yes |
| | gun settings in the display system. | |
| Show Accumulation | Allows the user to toggle the accumulation display | Yes |
| | in the display system. | |
| Show LaserPaint | Allows the user to toggle the display of the laser | Yes |
| | pointer in the display system. | |
| Show Camouflage | Allows the user to toggle the display of the | Yes |
| Overlay | camouflage overlay in the display system. Note: | |
| | This control is disabled when the lesson does not | |
| | specify camouflage painting. | |
| Current Score | The user's current score for the lesson is shown in | Yes |
| | this area. These update frequently to stay current | |
| | with the user's progress. | |
| Previous Scores | Previous lesson results are shown in this area. This | No |
| | includes all recorded scores that match the current | |
| | user and the current lesson. Scores are not shown in | |
| | Freeplay or Network mode. | |
| Pause | The simulation is paused. Elapsed time pauses and | No. |
| | painting is not permitted. This button text changes | |
| | to Resume when in Pause mode. If in Pause mode, | |
| | clicking Resume will start the Elapsed time counter | |
| | and enable painting. | |
| Exit | Closes the application. The user's scoring data will | Yes |
| | not be saved when selecting this option. | |

Note that once a lesson is completed, the student's performance is stored in the scoresheet database, box 216, FIG. 9, if the student selected training mode 206, but not if the student selected freeplay mode 208. Note that the in progress screen shown in FIG. 15 or a similar screen is shown on the graphical user interface when the user is in freeplay mode 208.

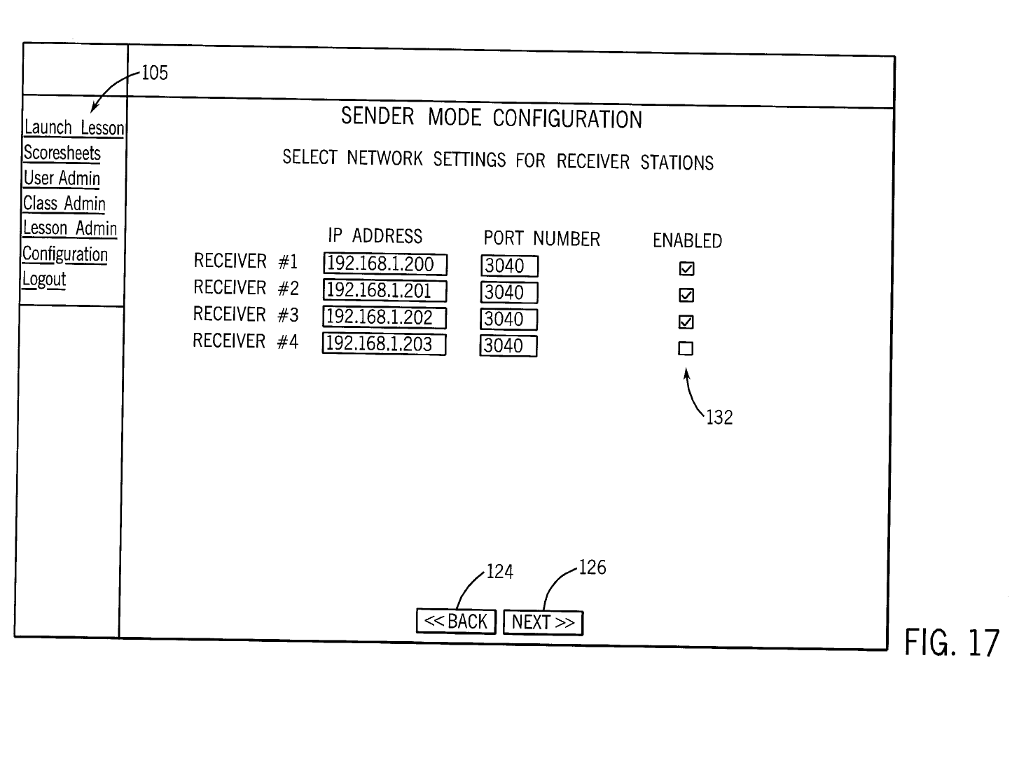

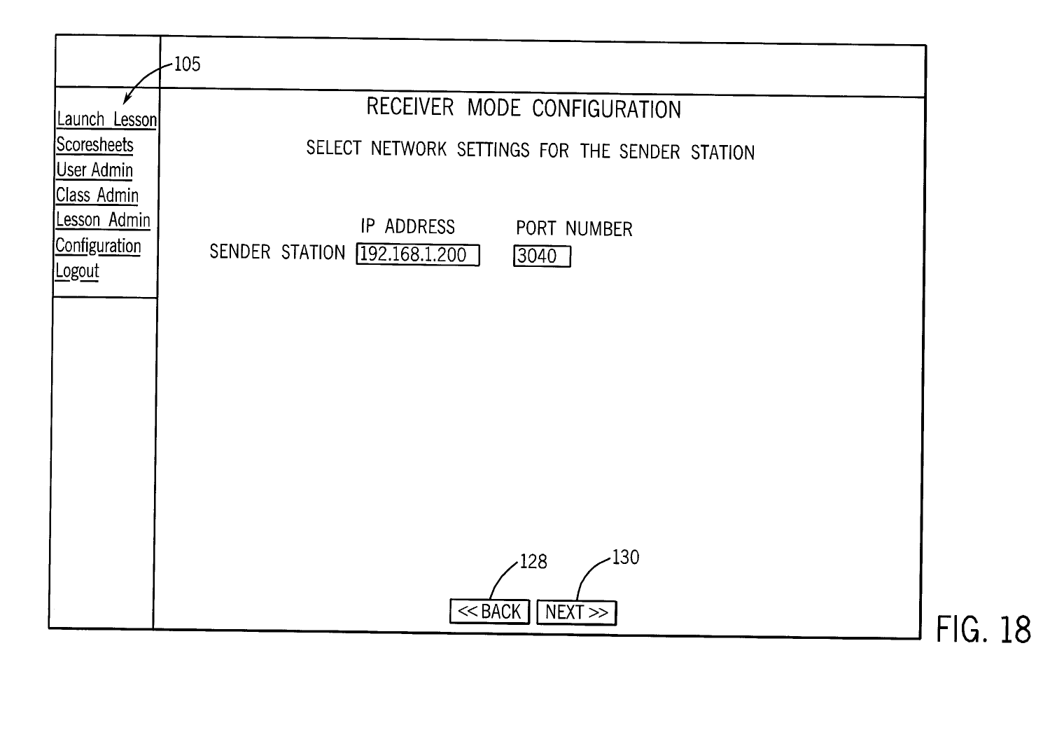

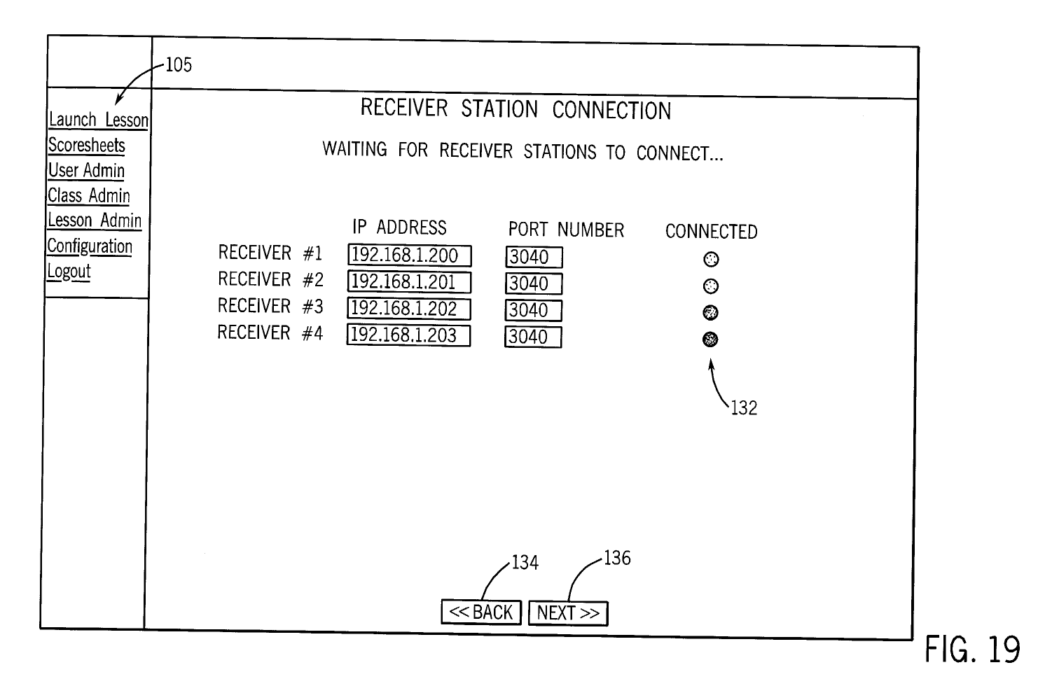

The network mode selection screen shown in FIG. 16 is displayed if the network mode 210, FIG. 9, is selected instead of the training mode 206 or the freeplay mode 208. The network mode selection screen (FIG. 16) allows the user to select either sender mode 118 or receiver mode 120. Preferably, only users logged-in as an instructor are able to select sender mode 118. If the user selects sender mode 118, and selects on the next button 122, the sender mode configuration screen (FIG. 17) is displayed, as illustrated in FIG. 9 by box 218. If the user selects the receiver mode 120 and selects the next button 122, the receiver mode configuration screen (FIG. 18) is displayed, as depicted by box 220 in FIG. 9. The sender mode configuration screen (FIG. 17) allows the user to specify network settings for the receiver stations 12 (or 112) that will be connected through the web-based network with the sender station 12 (or 112). In FIG. 17, settings for up to four receiver stations 12 (or 112) can be specified, although the software can be developed to allow for the connection of more or less receiver stations 12 (or 112). Note that the network settings include an IP address as well as, optionally, a port number. In addition, the screen in FIG. 17 includes a check box labeled “enabled”, which allows the user to specify which receiver stations 12 (or 112) will be connected during the present exercise. If the user selects the back button 124, the network mode selection screen (FIG. 16) is displayed. If the user selects the next button 126, the receiver station connection screen (FIG. 19) is displayed, as depicted by box 222 in FIG. 9.

As mentioned, the receiver mode configuration screen (FIG. 18) is displayed on the graphical user interface when the user selects receiver mode 120 from the network mode selection screen (FIG. 16). The receiver mode configuration screen (FIG. 18) allows the user to specify network settings (IP address and port number) for an instructor station to which a logged-in student station will be connected via the web-based network 102. If the student selects the back button 128, the network mode selection screen (FIG. 16) is displayed. If the user selects the next button 130, the lesson in progress screen (FIG. 15) is displayed on the graphical user interface for the student station 12 (or 112).

The receiver station connection screen shown in FIG. 19 allows a user signed in as a sender (i.e. an instructor) to monitor the network connections with the enabled receiver stations 12 (or 112). The receiver station connection screen (FIG. 19) contains a “connected?” indicator 132 for each receiver station. The indicators 132 indicate when a response has been received from the respective receiver station signifying that the receiver station is ready to receive data. Only the receiver stations that are marked as enabled on the sender mode configuration screen (FIG. 17) appear on the receiver station connection screen (FIG. 19). It may be desirable to combine the functionality of the receiver station connection screen (FIG. 19) into the Sender Mode configuration screen (FIG. 17). In either case, once a receiver station is connected, the display on the graphical user interface for the receiver (or student) station 12 or 112, as well as the images displayed on either the display screen 16 or the head-mounted display unit 98 are controlled by the instructor operating the sender (or instructor) station 12 or 112. In the case that the instructor is using a head-mounted display unit 98, and the student is using a head-mounted display unit 98, it may be desirable to add an additional two-dimensional display to the system 112 in order to allow other students (either at the location of the student or the location of the instructor) to observe the instructor's demonstration. If the instructor selects the back button 134 on the receiver station connection screen (FIG. 19), the sender mode configuration screen (FIG. 17) is displayed on the graphical user interface for the instructor station 12 or 112. The next button 136 is preferably disabled until all of the receiver stations are connected. When the instructor selects the next button 136 on the receiver station connection screen (FIG. 19), the lesson selection screen (FIG. 14) is displayed with all lessons marked as available, similar to the freeplay mode, as indicated in FIG. 9 by box 224. Network mode 210, as mentioned, allows an instructor to demonstrate technique for the lesson from a remote location.

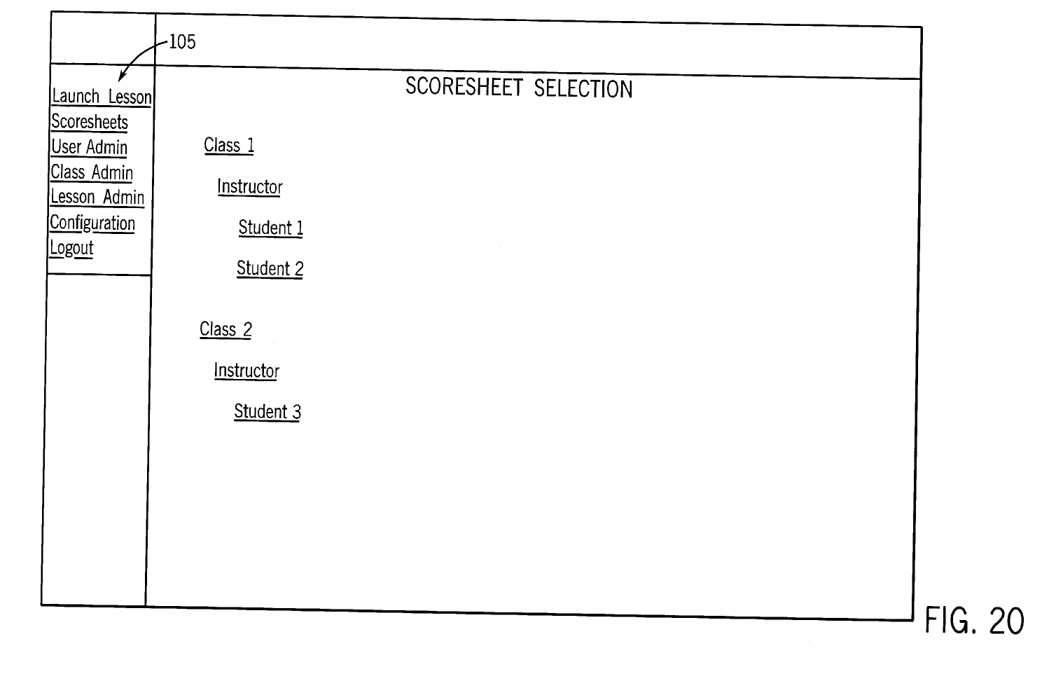

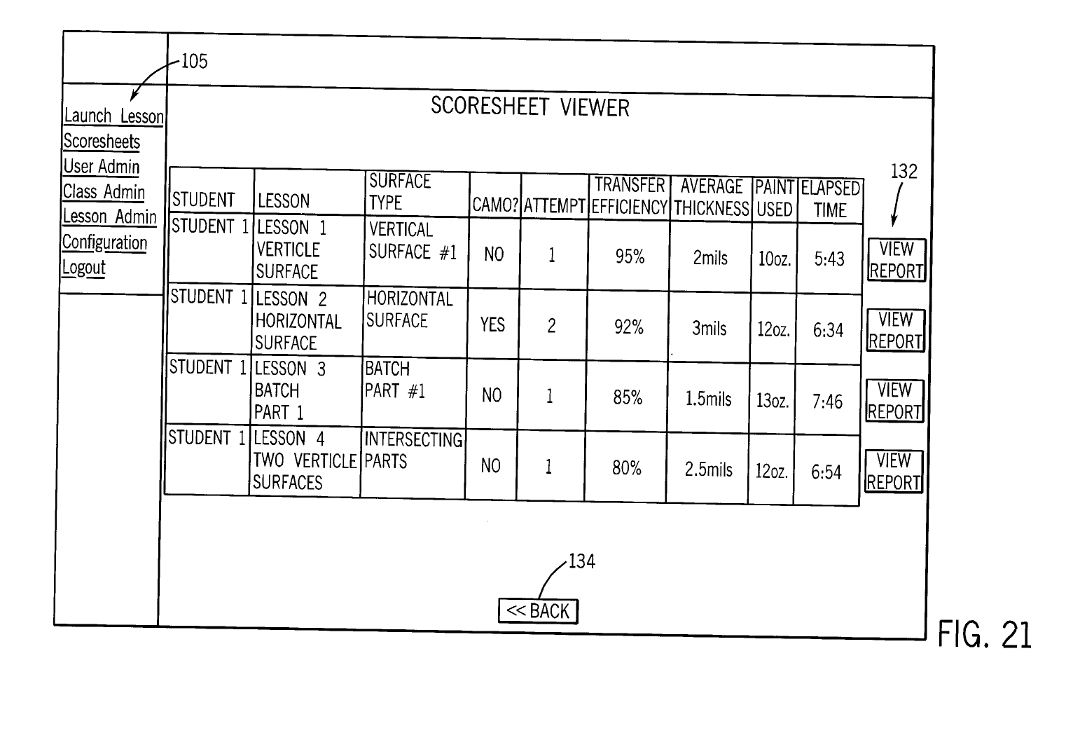

FIG. 10 shows the nesting of various screens when the “Scoresheets” option is chosen from the main menu 105. First, the scoresheet selection screen (FIG. 20) is displayed, as depicted by box 226 in FIG. 10. Then, the scoresheet viewer screen (FIG. 21) and subsequently the lesson report screen (FIG. 22) are available for the user to display, as depicted by boxes 228 and 230 in FIG. 10. If the logged-in user is a student, the system skips the scoresheet selection screen (FIG. 20), box 226, and displays the scoresheet viewer screen (FIG. 21) immediately, as depicted by dashed line 227 and box 228 in FIG. 10. Referring now to the scoresheet selection screen in FIG. 20, this screen (FIG. 20) allows the user (i.e. an instructor) to choose a class or student for which scores will be listed on the scoresheet viewer screen (FIG. 21). Note that the exemplary screen in FIG. 20 includes two different classes, each with an instructor and with different listed students. Choosing either the class name or the student name displays the scoresheet viewer screen (FIG. 21) with the requested data. If an instructor is logged in, all classes and all students are available for selection. However, as mentioned, if a student is logged in, the scoresheet selection screen (FIG. 20) is preferably skipped and the student will preferably go directly to the scoresheet viewer screen (FIG. 21). Referring to FIG. 21, the scoresheet viewer screen (FIG. 21) displays results from the previously completed lessons. FIG. 21 illustrates an exemplary view of the scoresheet viewer screen when an instructor has been logged in inasmuch as it lists lesson results for several students for which the instructor may want to review the results. Note that there is a separate row entry in the table for the results of each lesson. All recorded attempts at each lesson are displayed, as well as various metrics recorded for that lesson. For example, for each listed lesson there is a listing of the student name, the lesson name, the type of surface for the lesson, an indication of whether or not camouflage is used in the lesson, the number of attempts that the student has had at this particular lesson, and the transfer efficiency, average thickness, paint used and elapsed time for the student's last attempt for the particular lesson. In addition, there is a view report button 132 associated with each row of the scoresheet viewer table. By choosing the view report button 132 associated with a particular row, the system displays the corresponding lesson report screen (FIG. 22). If the user chooses the back button 134, the system displays the previous screen, i.e. the scoresheet selection screen (FIG. 20) if the logged in user is an instructor.

Referring now to FIG. 22, the lesson report screen (FIG. 22) provides a summary of the student's performance during a particular lesson. In the top portion 136 of the screen, information regarding the student and the lesson is displayed. This information is similar to the information displayed in the respective row of the scoresheet viewer table on the screen of FIG. 21, although it may be desirable to display somewhat more comprehensive data such as the age and experience level of the student, or the organization with which the student is associated. Note that the lesson report screen in FIG. 22 illustrates the date on which the lesson was taken, which is in addition to the information displayed on FIG. 21. The middle portion 138 of the lesson report screen (FIG. 22) displays a comparison of performance metrics for the completed lesson with those required for a passing grade. Again, the listed performance criteria include transfer efficiency, average mil thickness, minimum mil thickness, maximum mil thickness, paint used, elapsed time and percent OK. It also includes an overall score. In order to pass, the student must meet or exceed the standard for each metric. Alternatively, the system can require only a passing grade for selected one or more metrics in order to pass the student. For example, each of the performance metrics listed, except for the overall score, can be displayed as suggested student goals, and only a passing grade for an overall score is required for the student to pass. The lower portion of the screen 140 displays images 142 and 144 of the virtually painted surface. Image 142 shows the virtually painted surface in non-accumulation mode with overspray shown, and image 144 shows an accumulation view without overspray being shown. Note that the accumulation mode includes a color scheme which indicates in a first color (e.g. red) that the thickness is above the target value, indicates in a second color (e.g. green) that the thickness is near the target value, and indicates in a third color (e.g. blue) that the thickness is below the target value. The lesson report screen (FIG. 22) also includes a print button 146 which can be selected to print the report sheet to the default printer. Choosing the back button 148 will return the user to the scoresheet viewer screen (FIG. 21). A description of the determination of the values for each of the performance metrics displayed on the lesson report screen (FIG. 22) is listed below in Table 2.

TABLE 2
Metric Descriptions

| Metric Name | Description |
|---|---|
| Transfer Efficiency (%) | MassFinishDeposited |
| | MassFinishSprayed |
| Average Mil Thickness | Average thickness of paint over entire surface |
| Minimum Mil Thickness | Smallest thickness value on surface |
| Maximum Mil Thickness | Largest thickness value on surface |
| Paint Used (oz.) | Total finish sprayed from gun |
| Elapsed Time (mm:ss) | Total time of lesson |
| Percent OK (%) | Percentage of surface area that has a paint |
| | thickness that falls between the Minimum |
| | Mil Thickness and Maximum Mil |
| | Thickness |
| Overall Score | OverallScore − (30%) × |
| | (TransferEfficiency) + (70%) × |
| | (Percent OK) |

If the lesson reported in the lesson report screen (FIG. 22) is a camouflage lesson, it is preferable that the lower portion of the screen 140 display an image similar to that shown in FIG. 22A of the virtually painted surface. Referring to FIG. 22A, the camouflage painted surface is shown in non-accumulation mode with the background color (e.g. green) appearing in regions 83c and the overcoat colors (e.g. brown and black) appearing mostly in regions labeled 85c and 87c as the stippled regions. Also shown on image 143C is an overlay of the original chalk line 81c defining the desired boundary between the original background color 83 and the overcoats 85 and 87 (see FIG. 4A). Note that the virtually overlaid chalk lines 81c are thicker than the original virtual chalk lines 81 in order to account for allowable tolerance in following the underlying chalk lines 81. The areas 89c depict areas in which the overcoat went over the chalk line 81c by more than the allowable tolerance, whereas region 91c indicates areas where the overcoat was shy of the chalk line 81c.

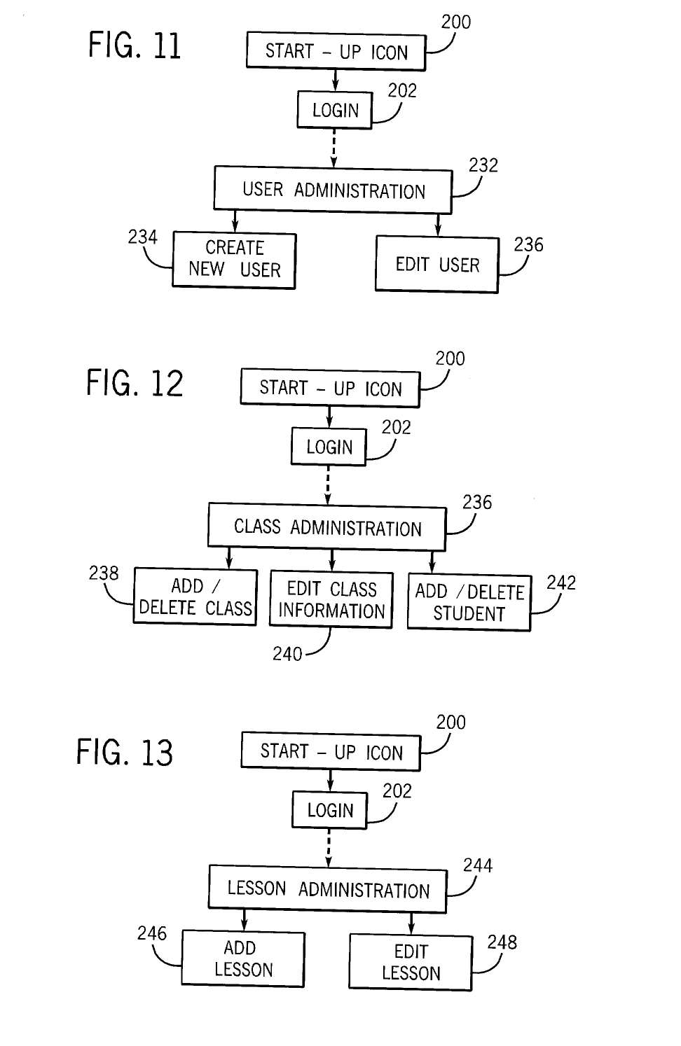

FIG. 11 shows the nested screens available when the “User Admin” link is selected from the main menu 105. Once an instructor has logged in, the user admin screen, depicted by box 232 in FIG. 11, is used to access a screen to create new users for the networked system 1, box 234 in FIG. 11, as well as access a screen that is used to edit information regarding existing users, box 236 in FIG. 11. The particular layout for screens to carry out the user administration functions is largely one of design choice. It is preferred that the user administration functions 232, 234 and 236 be accessible only if a user is logged in as an instructor. The user information should include a username, a password, the first and last name of the user, possibly an email address, and identify the user type as a student or as an instructor. The system should be able to add new users, as well as edit user information, and delete users from the system. Preferably, when a user is deleted from the system, all records for that user, including scoring data, are deleted. The designation of the user type as a student or as an instructor preferably sets the following rules associated for the type of user. For instructors, the available modes are freeplay and network. No scores are entered into the central database for instructors. All of the graphical user interface options listed on the main menu, namely, Launch Lesson, Scoresheets (for all users), User Admin, Class Admin, Lesson Admin, Configuration, and Logout, are available for instructors. On the other hand, for students, the available modes include the training mode as well as the freeplay and network mode. Also, for students, scores are entered into the central database when the student is in training mode. As a student, the only available menu options from the graphical user interface are Launch Lesson, Scoresheet (for current user only), Configuration, and Logout.

FIG. 12 illustrates the class administration function which can be accessed by the instructor. As depicted in FIG. 12, when the instructor accesses the class administration screen, as indicated by box 236 in FIG. 12, the instructor can then add or delete a class, box 238, edit the class information, box 240, or add or delete a student or instructor from the class, box 242. Preferably, a class can contain multiple students and at most, one instructor. If a class is deleted, the class is deleted from the database but the users that were assigned to that class are not deleted from the database.

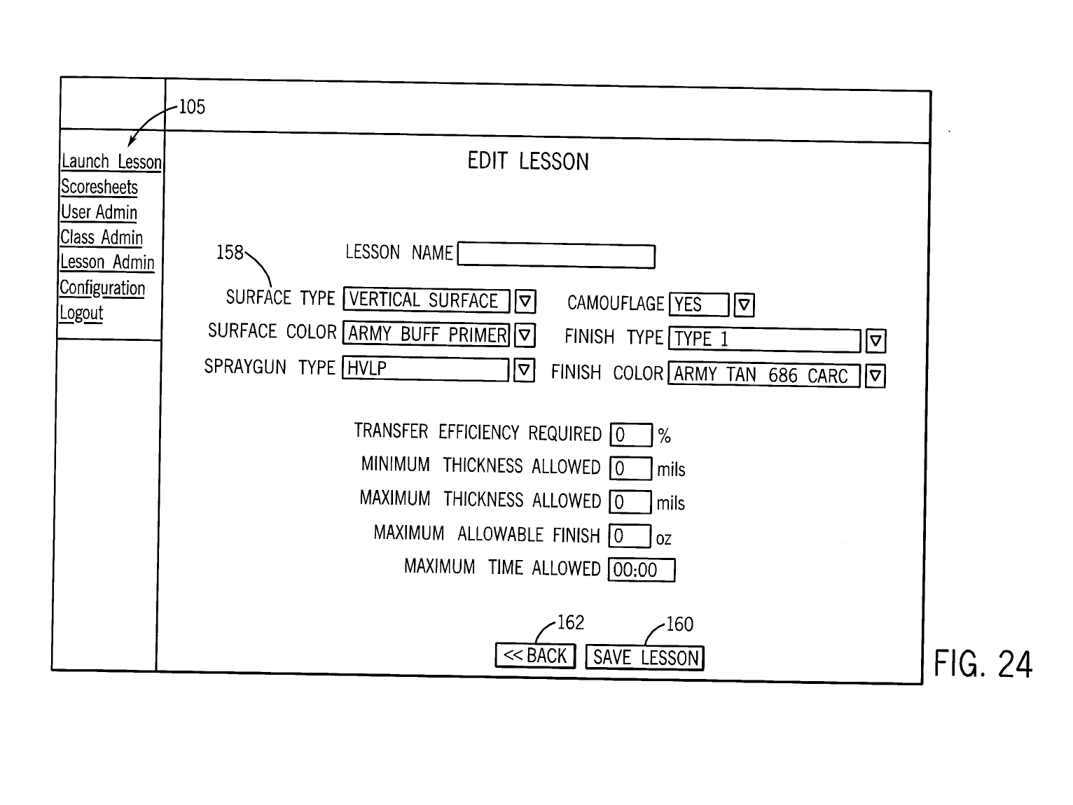

FIG. 13 illustrates the lesson administration functions. If an instructor chooses the Lesson Admin link from the main menu 105, the lesson administration screen shown in FIG. 23 appears as depicted by box 244 in FIG. 13. From the lesson administration screen (FIG. 23) the instructor can choose to add a lesson, as depicted by box 246 in FIG. 13, or edit an existing lesson, as depicted by box 248 in FIG. 13. Referring to FIG. 23, the lesson administration screen (FIG. 23) displays the currently stored lessons. The logged-in instructor can delete a lesson by selecting a delete lesson button 150, can edit a lesson by selecting an edit lesson button 152, or can add a lesson by selecting the add lesson button 154. The instructor can adjust the order of the lessons by using the up and down arrows 156 next to each lesson. The edit lesson screen is shown in FIG. 24. If the instructor chooses to add a lesson (button 154 in FIG. 23), the edit lesson screen (FIG. 24) is displayed with all fields blank for a new entry. The edit lesson screen (FIG. 24) prompts input for the lesson name, surface type, surface color, spray gun type, whether or not the lesson will use camouflage, finish type and finish color. It also prompts the instructor to enter the minimum passing value for various performance metrics, namely, transfer efficiency required, minimum thickness allowed, maximum thickness allowed, maximum allowable finish and maximum time allowed. The surface type prompt 158 allows the instructor to specify the shape and orientation of the part to be virtually painted. For example, the surface type can be a vertical rectangle, a vertically oriented vehicle door, a horizontally oriented flat surface, a vertically oriented batch part with distinct dimensions, etc. Camouflage is preferably supported with certain parts such as vehicle doors, and perhaps not supported with other parts such as various batch parts. The system stores the surface type data files for the configuration of the respective virtual surface that is to be painted. Preferably, these files are 3D Studio Max *.3ds files. Once an instructor enters values for each of the prompts on the edit lesson screen (FIG. 24), the instructor activates the save lesson button 160 to save the lesson data. If the instructor chooses the back button 162, the lesson administration screen (FIG. 23) is displayed.

If an instructor selects the “Configuration” menu option from the main menu 105 on the graphical user interface, the system preferably displays a calibrate tracker button which if selected will initiate a routine to calibrate the tracking system to track the position and orientation of the spray gun controller 18, and if the system uses a immersive head-mounted display unit 98, the head-mounted display unit 98 as well.

Turning now to the student display, either the display screen 16 shown in FIG. 1 or the head-mounted display unit 98 shown in FIG. 5, the student display provides a graphical view (e.g. FIG. 4 for station 12, or FIG. 6 for station 112) that includes both the virtual surface and an illustration of the accumulation of paint as the training session progresses. Based on the options set in the system, the student display may also include performance and spray gun setting information, as previously described. When a student's station 12 (or 112) is in network mode, a textual display is shown on the student display to notify the student when a connection with another station has been lost, such as when an instructor station disconnects. Conversely, an instructor station display receives an indication when a student station disconnects.

As described in copending patent application Ser. No. 11/539,352 incorporated herein, it may be desirable to provide a pop-up menu, or a permanent menu in the virtual environment on the student display so that the student can manipulate the controls with the spray gun controller 18. Note that when a student is in network receiver mode, certain controls cannot be activated, such as select finish color, pause/resume, or restart a painting session. Other menu options, such as toggles for audio, showing overspray, showing scores, showing settings, showing the laser guide features, showing an accumulation display, showing a camouflage overlay, preferably may be activated in the network receiver mode for a student. In addition, the painting complete option, which allows the user to signal the end of a lesson, should be available to a student in network receiver mode. In such case, the student will be prompted for exit options ensuring that the user desires to exit or complete the lesson, and prompting whether lesson results should be saved, or whether the user would like to continue to the next lesson, or if the user has not successfully completed the lesson, to retry the lesson.

Those skilled in the art will appreciate that the embodiments of the invention disclosed herein are illustrative and not limiting. Since certain changes may be made without departing from the scope of the invention, it is intended that all matter contained in the above description and shown in the accompanying drawings be interpreted as illustrative and not in a limiting sense.

We claim:

1. A networked system comprising:
at least a first and a second virtual coatings application station, each station comprising:
a display for displaying a virtual surface;
an instrumented spray gun controller outputting one or more signals representing virtual spray gun data;
a motion tracking system that tracks the position and orientation of the spray gun controller with respect to the virtual surface;
a graphical user interface; and
a computer programmed with software that generates virtual spray pattern data in response to at least the virtual spray gun data and the position and orientation data received from the tracking system, wherein a virtual spray pattern image is displayed in real time in accordance with the accumulation of virtual spray pattern data at each location on the virtual surface; and
a network connection between at least the first and second virtual coatings application stations which enables the image displayed on the display for the second station to be controlled by a person operating the first virtual coatings application station.

2. The system as recited in claim 1 wherein the first virtual coatings application station is operated by an instructor and the second virtual coatings operation station is observed by a student.

3. The system as recited in claim 1 wherein the display for the first and second stations are each a two-dimensional display screen.

4. The system as recited in claim 1 wherein the display for the first and second stations are each an immersive head-mounted display unit, and the system also tracks the motion of the respective head-mounted display units.

5. The system as recited in claim 1 wherein the system is a web-based system having a central database accessible by the computer for each of the respective stations.

6. The system as recited in claim 5 wherein the software for each station includes a user login procedure which associates the respective virtual coatings application station with the logged-in user.

7. The system as recited in claim 1 wherein the software includes a network mode selection procedure to set up the station as either a sender station or as a receiver station, said network mode selection procedure prompting the user for network settings for the receiver stations if the station is a sender station and prompting the user for network settings for the sender station if the station is a receiver station, and providing verification to the sender station that the receiver station is connected for communication with the sender station.

8. A method of structured training with a virtual coatings application station, the virtual coatings application station including a display for a virtual surface, an instrumented spray gun controller outputting one or more signals representing virtual spray gun data, a motion tracking system that tracks the position and orientation of the spray gun controller, a graphical user interface, a computer programmed with software which generates virtual spray pattern data in response to at least the virtual spray gun data and the position and orientation data received by the tracking system, wherein a virtual spray pattern image is displayed in real time in accordance with the accumulation of virtual spray pattern data at each location on the virtual surface, the method comprising the steps of:
providing a predefined training curriculum in the form of at least one virtual spray painting lesson having minimum performance standards set for selected performance criteria;
allowing a student to access the predefined training curriculum through the graphical user interface of the virtual coatings application station and select a lesson for completion with the virtual coatings application station; and
comparing performance criteria for the completed lesson with the minimal performance standard set for the lesson and passing the student if the performance criteria of the completed lesson meets or exceeds the minimum performance standard set for the lesson.

9. The method as recited in claim 8 wherein said at least one virtual spray painting lesson is a first lesson, and the method further comprises the step of requiring the student to pass the first lesson before making another lesson in the curriculum available for the student to access.

10. The method as recited in claim 8 wherein the predefined training curriculum is created using a lesson administration screen on the graphical user interface that prompts an instructor to input lesson parameters to create a lesson.

11. The method as recited in claim 10 wherein the lesson administration screen allows the instructor to rearrange the order of the lessons.

12. The method as recited in claim 10 wherein the lesson parameter inputs include at least an indication of the type of surface to be virtually painted, as well as the minimum performance criteria.

13. The method as recited in claim 12 wherein the minimum performance criteria includes required transfer efficiency; minimum thickness allowed, maximum thickness allowed, maximum allowable finish, and maximum allowed time.

14. The method as recited in claim 10 wherein the lesson administration screen provides a camouflage input prompt, which if activated causes the lesson to display a virtual chalk camouflage outline on the virtual surface, and the method further comprises the step of comparing the completed virtually painted surface to an overlay corresponding to the virtual chalk outline to determine whether the student has completed the lesson within a predefined tolerance range.

15. The method as recited in claim 8 further providing a lesson report which displays a comparison of the performance criteria for the completed lesson with the minimum performance standard set for the lesson.

16. The method as recited in claim 15 wherein the lesson report also illustrates a view of the completed virtual surface on the graphical user interface.

17. The method as recited in claim 16 wherein the lesson report illustrates the completed virtual surface in accumulation mode in which the thickness of finish on the surface is displayed in different colors depending on the thickness accumulated on the virtual surface at that point on the surface.

18. The method as recited in claim 16 wherein the illustration of the completed virtual surface of the lesson report is shown in overspray mode in which the overspray is displayed.

19. The method as recited in claim 16 wherein the illustration of the completed virtual surface on the lesson report also includes a camouflage outline overlay.

20. The method as recited in claim 8 wherein the recited virtual coatings application station is a single station in a system of virtual coatings application stations which are interconnected via a web-based network, the web-based network including a central database containing the lesson curriculum, the central database being accessible to virtual coatings application stations in the system, and wherein an instructor can make certain training curriculum available to a first class of students and another training curriculum available to another class of students.

21. The method as recited in claim 20 wherein the central database also contains lesson status and performance data for all the students entered into the system.

22. A virtual coatings application station comprising a display of a virtual surface, an instrumented spray gun controller outputting one or more signals representing virtual spray gun data, a motion tracking system that tracks the position and orientation of the spray gun controller, a graphical user interface, and a computer programmed with software which generates virtual spray pattern data in response to at least a virtual spray gun data and the position and orientation data received from the tracking system, wherein a virtual spray pattern image is displayed in accordance with the accumulation of virtual spray pattern data at each location on the virtual surface; and
wherein the graphical user interface provides access to a predefined curriculum of virtual spray painting lessons, and further prompts the student to choose between a structured training mode in which the student's performance for the lesson is stored in a scoresheet, and a freeplay mode in which the student's performance is not stored in a scoresheet.

23. The system as recited in claim 22 wherein the graphical user interface further prompts the student to choose between a network mode in addition to the structured training mode and the freeplay mode, and when the student selects the network mode, the student enables the virtual coatings application station to be controlled at least in part by an instructor operating another virtual coatings application station which is networked to the student's virtual coatings application station.
